(19) United States
(12) Patent Application Publication
(10) Pub. No.: US 2009/0129741 A1
(43) Pub. Date: May 21, 2009

(54) DISPLAY DEVICE FOR HAVING THE FUNCTION OF EDITING THE RECORDED DATE PARTIALLY AND METHOD FOR CONTROLLING THE SAME

(76) Inventor: Jeong Sim Kim, Gyeongsangbuk-do (KR)

Correspondence Address: KED & ASSOCIATES, LLP, P.O. Box 221200, Chantilly, VA, 20153-1200, US

(21) Appl. No.: 12/299,054

(22) PCT Filed: May 2, 2007
(86) PCT No.: PCT/KR2007/002149

§ 371 Date: Oct. 30, 2008

(30) Foreign Application Priority Data
May 2, 2006 (KR) 10-2006-0039721

(51) Int. Cl. H04N 5/76; H04N 5/45

(52) U.S. Cl. 386/52; 386/E05.001

(57) ABSTRACT

The present invention relates to a display device (101) having a function of editing recorded data partially and to a method for controlling the same. It includes a tuner unit (102), a decoding unit (103), a video processing unit (104), a display unit (105), a recording executing unit (106), a storage unit (107), a user input unit (108) and an encoding unit (109). The display screen (105) displays whole sections of a prescribed recorded data as a progress bar or a clock figure. It displays thumbnail images of a start part and an end part of at least one section to be encoded among the whole sections of the recorded data.

### TECHNICAL FIELD

The present invention relates to a display device, and more particularly, to a display device having a function of editing recorded data partially and method for controlling the same.

### BACKGROUND ART

Generally, the technological developments of video devices such as televisions, digital televisions, and the like bring a personal video recorder (PVR) capable of storing massive A/V data and outputting the previously stored A/V data at a user-specific timing point.

And, a video device equipped with a time machine or time-shift function for storing a broadcast stream transmitted by a broadcasting station by real time has been developed.

However, the related art video device and controlling method thereof have the following problems or disadvantages.

First of all, the related art video device fails to have a function of editing a specific recorded material in part and then storing the edited section as a separate file.

Secondly, in the related art video device, a recorded material or data is stored intact in a decoded data format. So, it is difficult to transfer an edited section of a specific recorded material or data to a memory of another external device.

### DISCLOSURE OF THE INVENTION

### Technical Solution

Accordingly, the present invention is directed to substantially obviate one or more of the problems due to limitations and disadvantages of the related art.

An object of the present invention is to provide a display device having a function of editing recorded data partially and method for controlling the same, by which a user is able to freely edit specific recorded data in a specific style.

Another object of the present invention is to provide a display device having a function of editing recorded data partially and method for controlling the same, by which the edited recorded data is encoded to be transferred to an external device for utilization with ease.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, a method of controlling a display device having a function of editing recorded data partially according to the present invention includes the steps of selecting at least one section to be encoded from whole sections of a prescribed recorded data by a user, encoding the selected at least one section of the recorded data, and storing data for the encoded at least one section of the recorded data in an internal memory or a memory of an external device.

Preferably, the method further includes the step of displaying the whole sections of the recorded data as a progress bar or a clock figure.

Preferably, in the step of encoding the selected at least one section of the recorded data, at least two discontinuous sections of the recorded data are connected to be encoded.

Preferably, the step of selecting the at least one section to be encoded from the whole sections of the prescribed recorded data by the user includes the step of displaying thumbnails of a start part and an end part of the at least one section to be encoded.

Preferably, the method further includes the step of displaying at least one information selected from the group consisting of a total time taken to play the at least one section to be encoded, an estimated memory size required for storing the at least one section to be encoded, and an estimated time taken for the encoding.

Preferably, the method further includes the step of displaying information for the external device in which the data for the encoded at least one section of the recorded data.

To further achieve these and other advantages and in accordance with the purpose of the present invention, a display device having a function of editing recorded data partially includes an input unit for a user to select at least one section to be encoded from whole sections of a prescribed recorded data, a recorded data encoding unit encoding the selected at least one section of the recorded data, and a control unit controlling data for the encoded at least one section of the recorded data to be stored in an internal memory or a memory of an external device.

Preferably, the display device further includes a display unit displaying the whole sections of the recorded data as a progress bar or a clock figure.

Preferably, the recorded data encoding unit executes encoding by connecting at least two discontinuous sections of the recorded data together.

Preferably, the display unit displays thumbnails of a start part and an end part of the at least one section to be encoded.

Preferably, the display unit displays at least one information selected from the group consisting of a total time taken to play the at least one section to be encoded, an estimated memory size required for storing the at least one section to be encoded, and an estimated time taken for the encoding.

Preferably, the display unit displays information for the external device in which the data for the encoded at least one section of the recorded data.

To further achieve these and other advantages and in accordance with the purpose of the present invention, in executing recording and storage, a display device having a function of editing recorded data partially includes a display screen displaying whole sections of a prescribed recorded data as a progress bar or a clock figure, the display screen displaying thumbnail images of a start part and an end part of at least one section to be encoded among the whole sections of the recorded data, the display screen displaying a progress status of an encoding work of the at least one section as a PIP (picture in picture), and the display screen, if the encoding work of the at least one section is completed, displaying information for the completion of the encoding work.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a configurational block diagram of a display device having a function of editing recorded data partially according to the present invention.

FIG. 2A is an exemplary diagram of an image on a display device having a function of editing recorded data partially according to a first embodiment of the present invention.

FIG. 2B is an exemplary diagram of an image on a display device having a function of editing recorded data partially according to a second embodiment of the present invention.

FIG. 2C is an exemplary diagram of an image on a display device having a function of editing recorded data partially according to a third embodiment of the present invention.

FIG. 2D is an exemplary diagram of an image on a display device having a function of editing recorded data partially according to a fourth embodiment of the present invention.

FIG. 3 is a flowchart of a method of controlling a display device having a function of editing recorded data partially according to the present invention.

### BEST MODE FOR CARRYING OUT THE INVENTION

### Mode for Invention

Reference will now be made in detail to the preferred embodiments of the present invention, examples of which are illustrated in the accompanying drawings.

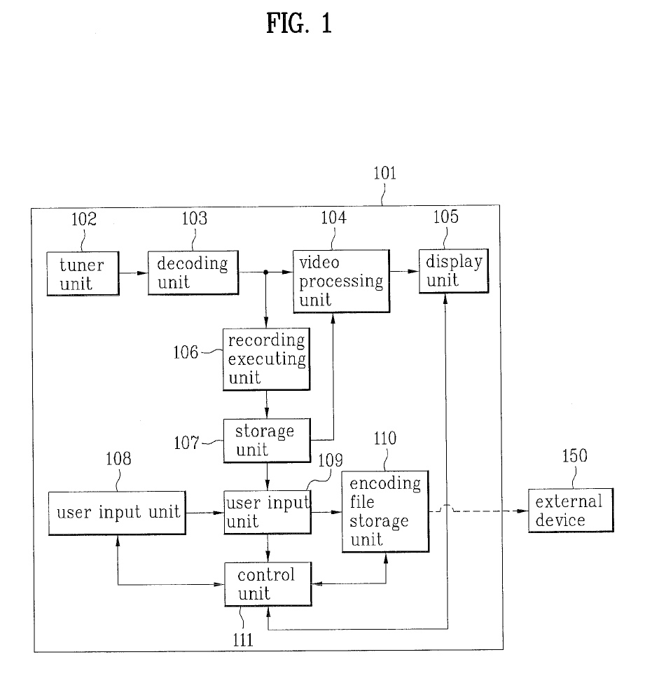

FIG. 1 is a configurational block diagram of a display device having a function of editing recorded data partially according to the present invention.

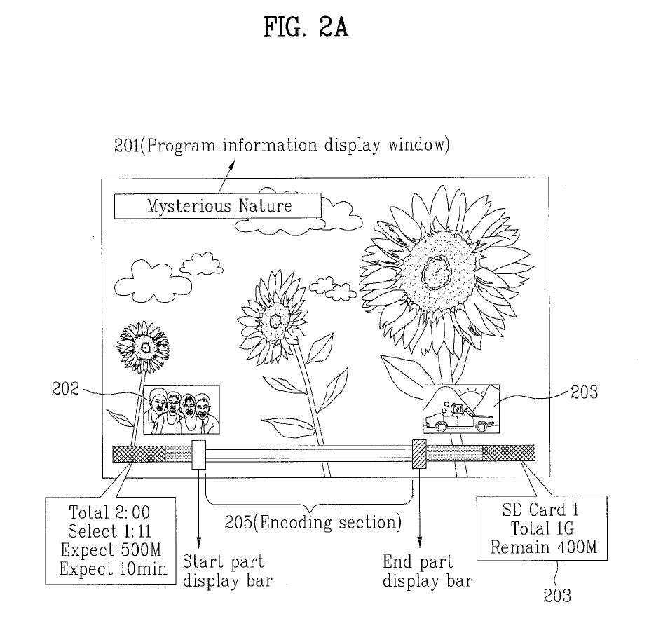

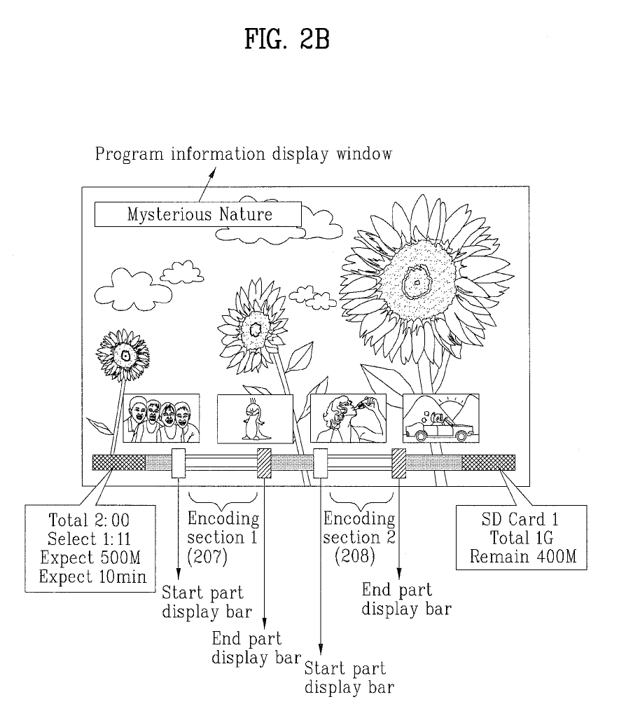

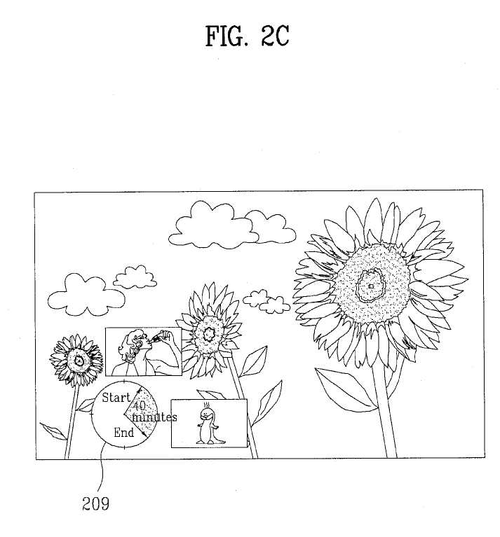

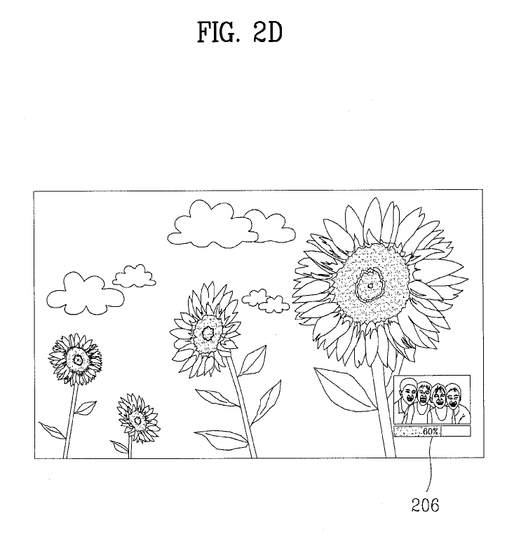

FIG. 2A is an exemplary diagram of an image on a display device having a function of editing recorded data partially according to a first embodiment of the present invention.

FIG. 2B is an exemplary diagram of an image on a display device having a function of editing recorded data partially according to a second embodiment of the present invention.

FIG. 2C is an exemplary diagram of an image on a display device having a function of editing recorded data partially according to a third embodiment of the present invention.

FIG. 2D is an exemplary diagram of an image on a display device having a function of editing recorded data partially according to a fourth embodiment of the present invention.

With reference to FIGS. 1 to 2D, an example of the control signal flow between elements of a display device having a function of editing recorded data partially according to the present invention and an example of providing a UI (user interface) image for setting a specific section to be encoded among the entire sections of the recorded data are explained as follows.

Referring to FIG. 1, a display device 101 according to the present invention includes a tuner unit 102, a decoding unit 103, a video processing unit 104, a display unit 105, a recording executing unit 106, a storage unit 107, a user input unit 108, an encoding unit 109, an encoding file storage unit 110, a control unit 111, and the like.

Meanwhile, there exists an external device 150 connected to the display device 101 to receive recorded data and edited recorded data previously stored in the display device 101.

The display device 101 includes a DTV (digital television), a PVR (personal video recorder), a DVR (digital video recorder), or the like.

The tuner unit 101 receives a specific broadcast program from a broadcasting station.

The decoding unit 103 decodes the specific broadcast program received via the tuner unit 102.

The video processing unit 104 performs signal processing on the decoded specific broadcast program into data in a format outputtable via the display unit 105.

The display unit 105 outputs the specific broadcast program signal-processed by the video processing unit 104 to a screen.

If a signal for a command for executing a recording is applied via a remote controller input or the like, the recording executing unit 106 makes the specific broadcast program, which has been decoded by the decoding unit 103, stored in the storage unit 107.

A process for implementing the present invention in correspondence to the specially added functions of the user input unit 108, the encoding unit 109, the encoding file storage unit 110, the control unit 111, and the like is explained in detail as follows.

First of all, if a signal for a command for executing an editing function for a specific recorded data is applied via the user input unit 108, the control unit 111 controls the display unit 105 to display an image shown in FIG. 2A.

A user is able to select a start part and an end part of a section to edit by referring to whole sections of a specific recorded data shown in a lower part of FIG. 2A. And, information for the selected section is delivered to the control unit 111 via the user input unit 108.

And, the section to be edited indicates the section to be encoded.

The control unit 111 reads information for the specific recorded data stored in the storage unit 107 and controls the information such as a program title and the like indicated by a reference number 201 shown in FIG. 2A to be outputted via the display unit 105.

The control unit 111 controls previously stored thumbnail images 202 and 203 for the start and end parts of the section, which is to be encoded by the user, among the whole sections of the specific recorded data to be outputted via the display unit 105. So. The control unit 111 facilitates the user to select the section to edit.

If the user inputs a-signal for confirming the start and end parts of the section to be encoded among the whole sections of the specific recorded data via the user input unit 10, the confirming signal is transferred to the control unit 111.

The control unit 111 reads out the information for the specific recorded data stored in the storage unit 107 and then controls information for a total play time of the specific recorded data, an estimated play time of the section to be encoded, an estimated memory size, a time taken to encoding, and the like to be outputted via the display unit 105.

Furthermore, the control unit 111 can control the display unit 105 to display information for an external mobile storage device, in which encoded data will be stored, indicated by a reference number 204 shown in FIG. 2A.

The external mobile storage device can include a memory card, a USB (universal serial bus) memory, and SD card, or the like for example.

And, the external mobile storage device can correspond to the external device 150 shown in FIG. 1.

The control unit 111 can control the section to be encoded among the whole sections of a progress bar of the specific recorded data, as shown in FIG. 2A, to be displayed as a different color.

The encoding unit 109 performs an encoding work on a prescribed section (e.g., reference number 205) of the specific recorded data stored in the storage unit 107 only under the control of the control unit 111.

Under the encoding work, the control unit 111 frequently checks an encoding status of the encoding unit 109 and controls a progress status of the encoding to be displayed in a PIP (picture in picture) format indicated by a reference number 206 shown in FIG. 2D.

According to another embodiment of the present invention, the display device makes the encoding work progress as a background work while enabling a user to view another broadcast program.

After completion of the encoding work, the control unit 111 controls the data for the encoded section of the specific recorded data to be stored in the encoding file storage unit 110.

According to an embodiment, the encoding file storage unit 110 and the storage unit 107 can be implemented with one memory.

If the encoding work is completed, the control unit 111 controls a speaker (not shown in the drawing) to generate a specific sound or controls the display unit 105 to output a prescribed message.

Although the embodiment shown in FIG. 2A relates to the example that there is a single section the user attempts to encode, the present invention is applicable to a case that there exist a plurality of sections 207 and 208, as shown in FIG. 2B, the user attempts to encode within one recorded data.

In this case, the display device may be able to respectively encode and store at least two encoding sections. Instead, by interconnecting and storing the at least two encoding section, the display device facilitates the editing for a user-preferring part.

Meanwhile, the display device can display the whole sections of the specific recorded data as a straight-line progress bar shown in FIG. 2A or a clock figure indicated by a reference number 209 in FIG. 2C.

Compared to that shown in FIG. 2A, this case shown in FIG. 2C can use a screen space more efficiently and meet various kinds of user tastes.

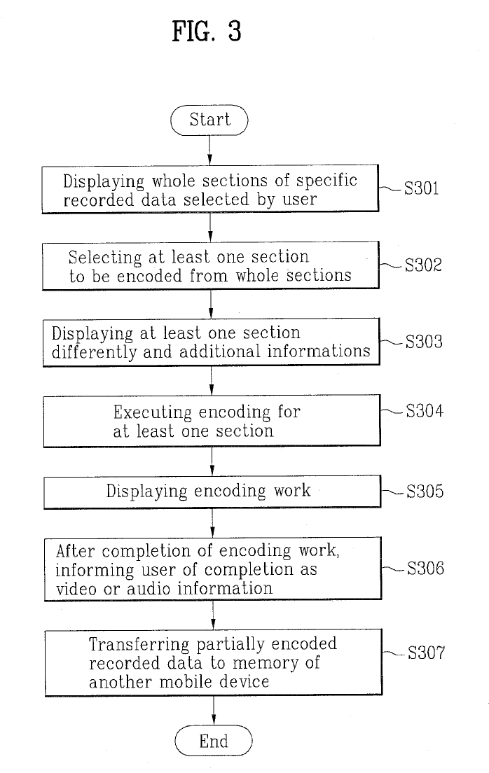

FIG. 3 is a flowchart of a method of controlling a display device having a function of editing recorded data partially according to the present invention.

In the following description, a method of controlling a display device having a function of editing recorded data partially according to the present invention is explained with reference to FIG. 3 (auxiliary reference to FIGS. 1 to 2D).

First of all, a display device displays whole sections of a specific recorded data selected by a user (S301).

For instance, it can be represented as a straight-line progress bar format shown in a lower part of FIG. 2A or a clock FIG. 209 shown in a left lower part of FIG. 2C.

The user selects at least one section to be encoded from the whole sections (S302).

For instance, the user can select one section 205, as shown in FIG. 2A, only or at least two sections 207 and 208 shown in FIG. 2B.

The display device displays the at least one section to be encoded to be discriminated from the rest of the sections and also displays additional information (S303).

The additional information can include information for a total playtime of the specific recorded data, an estimated playtime of the section to be encoded, an estimated memory size, a time taken to perform encoding, an external mobile storage device in which the encoded data will be stored, and the like.

The display device initiates an encoding work for the at least one section to be encoded (S304).

The display device displays a progress status of the encoding work on a screen (S305).

For instance, the progress status can be represented as a PIP (picture in picture) indicated by a reference number 206 shown in a right lower part of FIG. 2D.

If the encoding work is completed, the display device informs the user of the completion of the encoding work by outputting the corresponding information via a speaker, a screen or the like (S306).

The display device transfers the encoded data for the at least one section to a memory of the external mobile device (S307).

In this case, the external mobile device can include one of a memory card, a USB (universal serial bus) memory, an SD card, etc.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

### INDUSTRIAL APPLICABILITY

Accordingly, a display device of the present invention enables a user to select an encoding section of a specific recorded data freely to perform encoding.

And, the present invention encodes and stores a recorded data, of which section is freely selected and edited by a user, thereby facilitating the edited recording to be transferred to another external device and utilized.

1. A method of controlling a display device having a function of editing recorded data partially, comprising the steps of:
selecting at least one section to be encoded from whole sections of a prescribed recorded data by a user;
encoding the selected at least one section of the recorded data; and
storing data for the encoded at least one section of the recorded data in an internal memory or a memory of an external device.

2. The method of claim 1, further comprising the step of displaying the whole sections of the recorded data as a progress bar or a clock figure.

3. The method of claim 1, wherein in the step of encoding the selected at least one section of the recorded data, at least two discontinuous sections of the recorded data are connected to be encoded.

4. The method of claim 1, the step of selecting the at least one section to be encoded from the whole sections of the prescribed recorded data by the user, comprising the step of displaying thumbnails of a start part and an end part of the at least one section to be encoded.

5. The method of claim 1, further comprising the step of displaying at least one information selected from the group consisting of a total time taken to play the at least one section to be encoded, an estimated memory size required for storing the at least one section to be encoded, and an estimated time taken for the encoding.

6. The method of claim 1, further comprising the step of displaying information for the external device in which the data for the encoded at least one section of the recorded data is stored.

7. A display device having a function of editing recorded data partially, comprising:
an input unit for a user to select at least one section to be encoded from whole sections of a prescribed recorded data;
a recorded data encoding unit encoding the selected at least one section of the recorded data; and
a control unit controlling data for the encoded at least one section of the recorded data to be stored in an internal memory or a memory of an external device.

8. The display device of claim 7, further comprising a display unit displaying the whole sections of the recorded data as a progress bar or a clock figure.

9. The display device of claim 7, wherein the recorded data encoding unit executes encoding by connecting at least two discontinuous sections of the recorded data together.

10. The display device of claim 8, wherein the display unit displays thumbnails of a start part and an end part of the at least one section to be encoded.

11. The display device of claim 8, wherein the display unit displays at least one information selected from the group consisting of a total time taken to play the at least one section to be encoded, an estimated memory size required for storing the at least one section to be encoded, and an estimated time taken for the encoding.

12. The display device of claim 8, wherein the display unit displays information for the external device in which the data for the encoded at least one section of the recorded data is stored.

13. A display device having a function of editing recorded data partially, including a display screen displaying whole sections of a prescribed recorded data as a progress bar or a clock figure, the display screen displaying thumbnail images of a start part and an end part of at least one section to be encoded among the whole sections of the recorded data, the display screen displaying a progress status of an encoding work of the at least one section as a PIP (picture in picture), the display screen, if the encoding work of the at least one section is completed, displaying information for the completion of the encoding work.
